(19) United States
(12) Patent Application Publication
(10) Pub. No.: US 2021/0334092 A1
(43) Pub. Date: Oct. 28, 2021

(54) System For Providing Instant Preview Of A Mobile Application Under Development

(71) Applicant: MUVI LLC, Liverpool, NY (US)

(72) Inventors: ANSHUMAN DAS, Liverpool, NY (US); PRAGYAN PRIYADARSHINI, BHUBANESWAR (IN); SATYA PRAKASH DAS, BHUBANESWAR (IN); ABHINAV MOHANTY, BHUBANESWAR (IN)

(21) Appl. No.: 17/369,246

(22) Filed: Jul. 7, 2021

Related U.S. Application Data
(63) Continuation-in-part of application No. 16/056,599, filed on Aug. 7, 2018, now abandoned.
Application No. 16/056,599 is a continuation-in-part of application No. 16/880,753, filed on May 21, 2020, now abandoned.

(51) Int. Cl. G06F 8/71; G06F 8/34; G06F 8/33

(52) U.S. Cl. CPC G06F 8/71; G06F 8/33; G06F 8/34

(57) ABSTRACT

A system is provided giving an instant preview of the appearance of a compiled native application on a mobile computing device during an application development process as the application would appear as if installed from a digital distribution platform such as an app store, without compiling the application. The system previews an accurate representation of the appearance of the app in the user interface without compiling the app, and the content management modules allows the user to iteratively change the elements to obtain a desired appearance for the app.

### CROSS REFERENCE TO RELATED APPLICATION(S)

This application is a continuation-in-part of U.S. patent application Ser. No. 16/880,753, filed May 21, 2020, which was a continuation of U.S. patent application Ser. No. 16/056,599, Aug. 7, 2018, the contents of each of which are incorporated by reference.

### FIELD OF THE INVENTION

A system is disclosed for mobile computer application development, wherein mock-ups of screen content and a user interface of a mobile application are instantly previewed without generating code for the application and without using an app store.

### BACKGROUND

Modern mobile devices such as smartphones, tablets, and wearables use mobile operating systems such as Apple iOS® or the ANDROID® operating system. The favored method of presenting information and interacting with users in mobile operating systems is through mobile applications (“apps”) rather than webpages. Mobile apps are generally felt to have certain advantages, such as better performance than mobile webpages, have an improved user experience that can be more easily controlled than on a webpage, and can offer offline use. Traditional development of apps for mobile devices and certain desktop apps requires new code to be written for each new application. This code is compiled using one of several available tools and should be tested for bugs, and then submitted to a mobile application store (an “app store”) and downloaded by the end user. In general, mobile operating systems are limited in scope and what can be installed, and under normal conditions, for most users, mobile operating systems only permit apps to be used that are delivered from an app store. Changes or updates required to traditional development call for modifications to the original code, re-submission to a mobile application store, and a re-download by the end user. This entire process, even for a minor update, requires approximately three weeks at a minimum, in which one week is used to update and test the code by the developers, and then approximately two weeks for vetting by the app stores.

An app developer wishing to develop a mobile application for an iPHONE® mobile phone must create the mobile application using an iOS® platform. The app developer may need to download an integrated development environment (“IDE”) such as XCODE™ or an application development tool such as COCOA TOUCH®. Also, the mobile app must be certified by Apple.

If the app developer wishes to have that mobile application available for an ANDROID® phone, then the app developer must create a new mobile application using an ANDROID® operating platform. The app developer may need a JAVA® development kit (“JDK”), ECLIPSE™ IDE, the ANDROID® SDK, and the ANDROID development tools plug-in.

Some of the differences between just these two platforms include multitasking, widgets, application market restrictions (Apple must certify all iOS® apps), notifications, multiple hardware devices (only Apple devices use the iOS® platform), editable ROMS (the iPHONE® mobile phone has a read-only memory), and settings changes.

Mobile application owners or developers have the option of creating wireframes to check design and working of the mobile application. The wireframe typically lays out the interface of the application and presents visually the way that a user will interact with the application software. From the wireframing, the application development cycle goes through design, layout, coding, manual testing, review, automation testing and build deployment to publish.

Apps on mobile operating systems such as iOS® or ANDROID® are normally only accessible from an app store, such as the Apple App Store, the Google Play Store, the Samsung Galaxy Store, or the Huawei AppGallery. The use of these app stores is in contrast to older operating systems such as Windows® or Apple Macintosh® that allow users to install apps from installation files that can come from anywhere. The use of app stores may provide improved security and payment handling systems and other resources that increase convenience for users.

With any conventional app development process, the code is typically compiled and uploaded to a device for review. Non-final versions of the code must then be deleted. The process is lengthy and requires various professionals and tools to create and package a native application. None of the existing systems allows the developers and their clients to get an accurate feel of a mobile app, for example for iOS® or Android®, until the app is compiled and published in the play store. This is a shortcoming of prior art purporting to shortcut and streamline the app development process. For example, the disclosure of U.S. Pat. No. 8,261,231 B1 (the '231 patent) purports to provide an easy-to-use, intuitive user interface that does not require users to possess expertise in computer programming or mobile devices to allows users to create sophisticated applications. However, the '231 patent does not provide a method of simulating the look and feel of an app without actually compiling code or publishing the app in an app store. Likewise, US2012/0174079 A1 describes shortcuts in an app development process with the use of a simulator but does not disclose systems that rely on an app store which requires an extra layer of effort by app developers for mobile operating systems.

### SUMMARY OF THE INVENTION

This invention addresses a need to simulate the look and feel of an application compiled and operating on a mobile device that uses a mobile operating system, where applications are normally installed from an application store, without actually compiling code or publishing the application in an app store. This invention therefore provides an emulator for mobile application development.

This invention further provides a content management system (CMS) providing an environment allowing developers to add and arrange visual elements of a mobile application on a screen, and to display the elements in real time on a mock-up of the application.

The display in the inventive CMS is only a replica of an app. The inventive method does not require writing code compile code nor does the method produce an actual application suitable for uploading on an app store. This method allows developers and customers to view the visual elements of the application for evaluation of a user-interface and other aesthetic features of the app.

This invention is applicable to devices running, for example, iOS®, Android®, and other Linux®-based operating systems, which operate generally on mobile devices such as smartphones, tablets, Chromebook™ computers, IoT (“internet of things”) devices. This invention may also be applicable to app development on full featured operating systems, including Windows® and Apple macOS®.

Accordingly, in an embodiment, a system is provided for an instant preview of the appearance of a compiled native computer application during an application development process where the computer application operates on a mobile computing device and wherein the computer application is not compiled during the preview. The system may include an authorization and display app having a user interface running on a mobile computing device using a mobile operating system where applications are normally only installed from an application store. The authorization and display app may be in network communication with a Content Management System (CMS) server having at least an application module, a user database, and a content database. The user database may store user information and one or more user templates. The content database may store content data files selected by the user. An authentication system may be provided that accepts user credentials on the authorization and display app and connects the user to the CMS server from the authorization and display app using the user credentials. The user may be able to select user templates and content files when logged in to the CMS server wherein the user templates and content are intended for use as a compiled native computer application operating on a mobile computing device. The application module may then merge selected user templates and content files and render a preview of the compiled native application on the user interface of the authorization and display app without compiling computer code.

Accordingly, in an embodiment, a system is disclosed for providing an instant preview of the appearance of a compiled native application on a computing device during an application development process. In an embodiment, the system includes a database, a processing unit, and a user interface, where the user interface has input (keyboard and mouse) and output (video and audio) for interacting with users of the system. The database may store a plurality of modules comprising one or more of a content management module and an application template module. Other modules may be included also. The application template module includes one or more application templates, and an application template is selected and loaded into the content management module. The application templates provide application elements and features that can be included in a native application. In an embodiment, the content management module presents in the user interface one or more menus and application elements according to the selected application template that are selected and arranged by a user. The selected elements may be stored in the database for access by other modules and other processes. The processing unit processes the elements in the content management module and previews an accurate representation of the appearance of the app in the user interface without compiling the app. In addition, the content management module may allow the user to iteratively change the elements to obtain a desired appearance for the app.

In an embodiment, the system may be presented to users on a website operating a web-based application.

In an embodiment, the the application template module running in the content management module is designed to preview a native application operating on an operating system selected from Android®, iOS®, Windows®, macOS®, and other lightweight operating systems. In an embodiment, the application template module running in the content management module is designed to preview a native application operating on a computing device selected from a smartphone, a computer tablet, a lightweight Linux® computer, an Apple® Macintosh®, and a Windows computer.

In an embodiment, the application template module allows users to update the selected application template, and the customized native application displays a preview of the input content in the updated selected application template on refreshing. The application template module may further comprise a menu module to allow users to create a customized menu for displaying in the selected application template. The application template module may further include a user interface (UI) color scheme module to allow users to select color scheme using a color palette selector, wherein the UI color scheme is adapted by the selected mobile application template.

In an embodiment, the application template is designed for video or audio streaming content. The application template may also provide an e-commerce store.

In an embodiment, the plurality of modules further comprises an application creation module for creating a ready-to-publish application for distribution on digital distribution platforms, wherein the ready-to-publish application comprises the selected application template with the input content and the application creation module is linked to the application template module and the content management module. The application creation module may create a compiled application that can be distributed on a digital distribution platform. The digital distribution platform may be an app store.

### DESCRIPTION OF THE DRAWINGS

FIG. 1 is a flowchart showing prior art app development procedures compared to the inventive method.

FIG. 2 is a schematic of an overview of the development process of this invention.

FIG. 3 is a flowchart showing certain details of the inventive system.

FIG. 4 is a block diagram showing the relationship of certain features of the inventive system.

FIG. 5 a block diagram of a system for providing instant preview of a customized mobile application in accordance with an embodiment of this invention.

FIG. 6 is a screenshot showing of a template customization module in accordance with an embodiment of the present invention.

FIG. 7 is a screenshot showing of the content management module in accordance with an embodiment of the present invention.

FIG. 8 is a screenshot showing of an application module previewing of the input content in the selected application template.

FIG. 9 is a screenshot showing of a menu module in accordance with an embodiment of the present invention; and

FIG. 10 illustrates a screenshot showing of a template creation module in accordance with an embodiment of the present invention.

### DETAILED DESCRIPTION

There are two kinds of programming languages that developers use to build desktop, web, and mobile applications: compiled and interpreted. Interpreted languages produce code that a computer can understand immediately. The most obvious example of this are web pages, where for example HTML, Javascript®, or PHP code (interpreted languages) is sent to a web browser which interprets the code and displays a web page. Compiled languages produce code that needs to be compiled in order for the machine (computer) to understand. Examples of this type of code are written in Java®, Swift®, Python®, and C++. This type of code is written in a development environment, and must be compiled with a compiler that converts the language code to machine language and creates an app with various ancillary requirements, such as access to memory, networking services, disk drive storage, keyboard input, and graphic output. As a general rule, most free-standing computer applications are written in compiled code because such applications do not depend on another application (such as a web browser to run) and typically can be made more economical in terms of computer resources than code in an interpreted language. After compiled code is compiled, the application can be installed and run on a computer. This disclosure uses the word “application” or “computer application” synonymously with “computer program,” meaning computer code supplied as a package, whether interpreted, or compiled, that is installable and operable on a computer that performs some function on the computer. The type of app is not limited by the instant invention.

In an embodiment, the device that runs the inventive app may be an “OTT” (over-the-top) device that provides streaming video or audio content to consumers. In an embodiment, the device may be an “IoT” (internet of things) device, that is a network-connected appliance that provides some kind of functionality for residential or commercial use. In an embodiment, the device running the inventive app may be a smart phone or computing tablet device. Regardless of the device, in an embodiment, the device is of a type that normally loads apps from an app store.

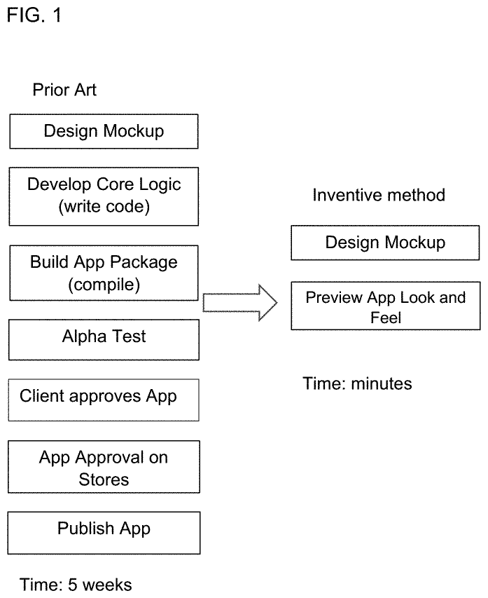

FIG. 1 shows a broad overview of an application (app) development process as disclosed herein, comparing the prior art and the inventive method. Traditional App development cycle ranges anywhere from 5 to 10 weeks, even with reusable modules. A prior art typical app development process requires the following steps:
a. Design the screens in photoshop or similar tool (design mock-up) (600);
b. Develop the software keeping the design in mind; develop core logic and write code (610);
c. Build the APK or IPA file (this is the compilation step) (620);
d. Send to client for testing (alpha testing); alternatively, 3rd party software such as TestFlight® provides this as a service (630);
e. Client approves the app (640);
f. Submit to app store; wait for approval (650);
g. Publish the app in app store (660).

The prior art method does not allow the developers and clients to get an actual feel of the mobile application until it is published in an app store. With mobile devices, an APK (compiled file for Android®) or IPA (compiled file for iOS®) file can be installed on a device in developer mode, but this is a time-consuming process requiring substantial extra steps even for experienced developers and is particularly difficult or impossible for non-experts. Both iOS and Android devices make installing apps off the store intentionally difficult. As used herein, an “app store” means a repository of apps for a particular operating system or device, and includes repositories such as Google Play™, the Apple App Store®, or Samsung Galaxy® Store. Therefore, there is a need of a system for providing customized and instant preview of a mobile application in real time.

Also shown in FIG. 1 is a block diagram of the inventive system, which is a two-step process:
a. Design screens in the CMS (600)
b. Preview the appearance of the design in real time (670).

The prior art takes many weeks to complete. The inventive system can be prototyped and previewed in a few minutes. The preview of the app can be thought of as a simulated view of an actual app.

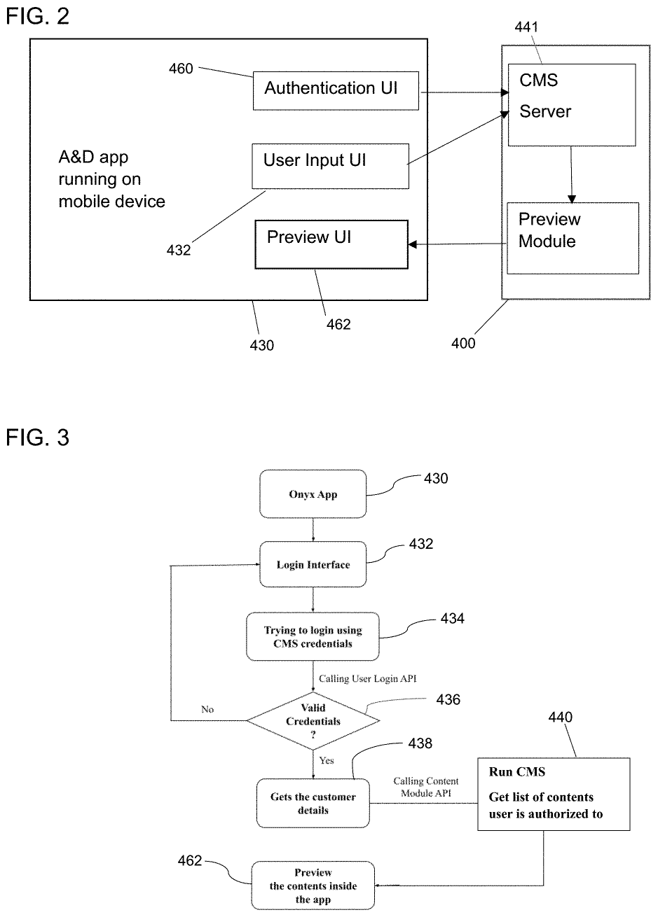

FIG. 2 is a broad overview of the inventive system, showing the authentication and display app 430 which has three major components, an authentication user interface (UI) (460) that accepts user credentials and transmits them to the CMS server (also termed the “Muvi” CMS server herein). Also shown is a user input UI 432 that allows users to select templates, elements, and content to create an app. Also included is a preview interface 462 that accepts data from the CMS server and displays a preview for the user to allow the user to see the appearance and functionality of the app. Various components labeled 423 (explained in further detail below) generate the preview data for the preview UI 462.

FIG. 3 is a flow chart showing several steps of the inventive system. The inventive system relies on an authentication and display app 430 provided by the developer of the inventive system, and downloadable on an app store. The authentication and display app is also termed “Onyx” here. Starting with the authorization and display (A&D) app 430 downloaded from an app store and running on a mobile device such as an iPhone® or Android®, the user logs into a content management system (CMS) server with user credentials (step 434). The login process employs a login interface 432 that is a component of the A&D app. The credentials are evaluated at step 436. If rejected, the control is returned to the A&D app user interface to allow the user to try again. If the credentials are accepted, the system gets customer details at step 438, and runs the CMS (step 400), which allows users to preview an app (462) being developed inside the A&D app.

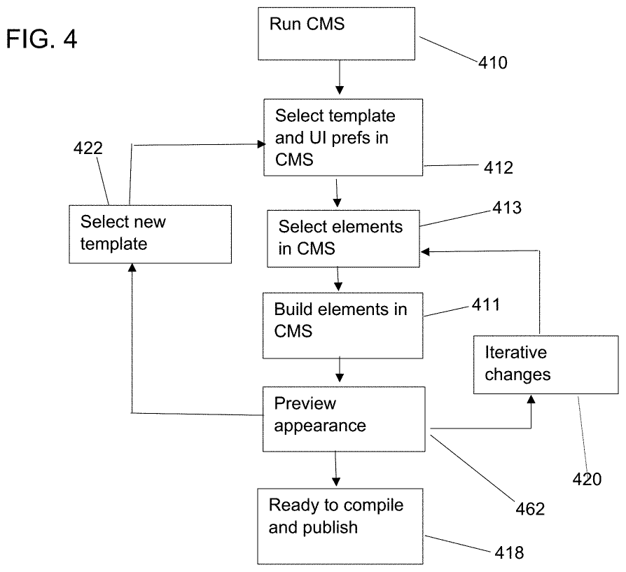

FIG. 4 is a schematic showing certain details and steps of an application (app) development process as disclosed herein. In an embodiment, the inventive system includes a content management system (CMS) 410 which may be an application with a web-based user interface. A number of templates (412) may be available in the CMS allowing application elements, design variations, and as color schemes, that the developer can select to obtain a desired look and feel for the app.

The application template step 412 allows registered users to select one of several mobile application templates. The templates provide, for example, a framework for the look and feel of an application, including design and layout, fonts, artistic elements, and a color scheme. These are all part of the “look and feel” of an application that can vary depending on the target audience. For example, an app directed at business users will likely have a more business-like look and feel than an app directed at children. At step 422, the user can select new templates in an iterative fashion. The system according to this invention may provide several templates. A selected application template is sent to the next step (411) where elements are assembled in the CMS for display to the user in the A&D app.

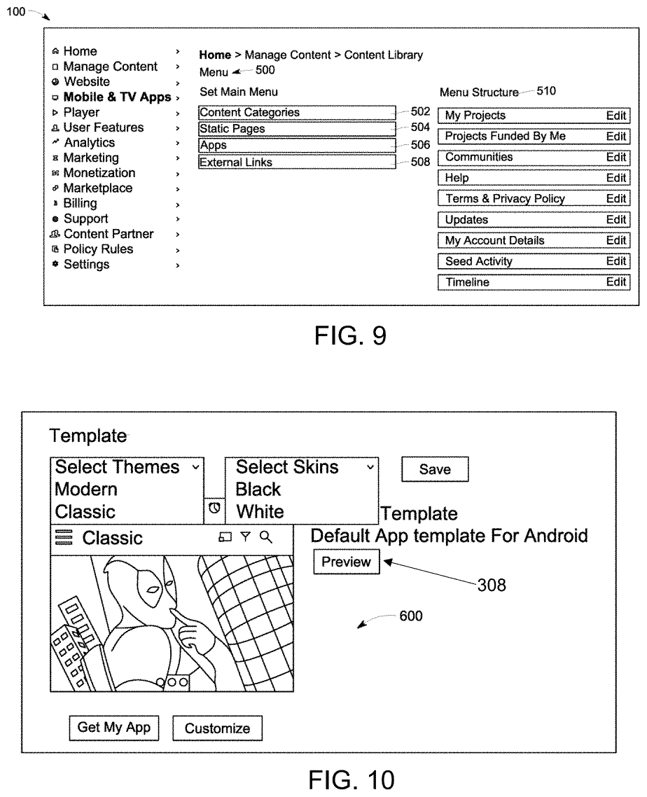

The content management module at step 413 allows registered users to create and add elements of an application within the selected template. By the term “elements,” it is meant features such as buttons, menus, drop boxes, lists, links, text, graphics, music, video content display and the like that comprise visual and functional elements of a computer application. The elements, the arrangement and position of elements, and the selected template are stored in the database. The arrangement of elements is explained in detail in conjunction with FIGS. 7 and 9 discussed below. In an embodiment, the template is designed for managing, selecting, and displaying video or audio streaming content, but the inventive method is not limited to this type of content. Also within the scope of this invention are the creation of apps that display information or provide interactive methods, such as e-commerce stores, payment systems, weather apps, or transportation schedules. By “e-commerce” it is meant apps that present a menu of products or services that a user can select and purchase. E-commerce apps must also therefore include authentication mechanisms and payment systems, such as accepting credit cards.

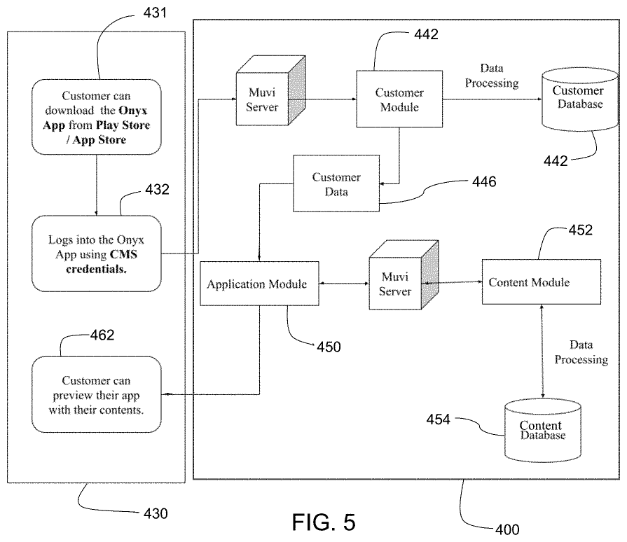

At stage 411, the app is assembled with the selected template(s) and selected elements such as buttons, menus, drop boxes, lists, links, text, graphics, music, video content display and the like that comprise visual and functional elements of a computer application. The look and feel of the app can then be previewed in the preview interface 462. The point of this is to show an accurate preview of the visual appearance of the app that may have some limited functionality, such as displaying selected content, to show the developer how the final app will appear, without having to compile code. Further detail of the step between assembly of the components in the CMS at step 411 and the preview stage are shown in FIG. 5. At step 420, the developer can make iterative changes to change the various elements. At step 422, the developer can select a different template for the CMS and start again at step 412. When the developer is satisfied, the app can be sent to later stages (418) that compile code into a complete app for upload into an app store and distribution to customers.

FIG. 5 illustrates further detail of an embodiment of the steps to show a preview of an app without compiling code in the inventive system. Box 430 represents the A&D app (also called “Onyx” herein), which can be downloaded and installed on a mobile device from an app store (431). The A&D app may include a user interface (432) for entering user credentials to log in to the CMS server. The credentials are passed via network communication to the Muvi CMS server 400 which includes customer module 442. The customer module 442 verifies the user credentials, and if accepted, retrieves customer data (446) from user database 444. This data may include templates, themes, elements and other information used in the creation of an app for the user. Examples of the database 444 include but are not limited to database systems such as MySQL®, Dynamo®, Mongo® etc. At this stage, customer module 442 also allows users to select and modify templates.

By the term “network communication” herein, wireless communication is meant. In an embodiment, the Onyx A&D app runs on a mobile device, and communication with the Muvi CMS server 400 is normally via a data connection over the cellular network or via Wi-Fi, which refers to wireless communications using IEEE 802.11 standards.

The customer module 442 produces customer data 446 which is sent to application module 450. The application module makes another query to content module 452 and retrieves a listing of content data associated with the user from database 454. In an embodiment, the content may be video files, photo files, audio files, or documents. Examples of the database 454 include but are not limited to database systems such as MySQL®, Dynamo®, Mongo® etc.

The application module 450 merges the customer data and customer content to render a preview of the app under development on the user interface (UI) 462 of the A&D app. In an embodiment, the user logs into the CMS with the A&D app, the CMS manages the assembly of the app under development, and the CMS displays the app within the A&D app without actually compiling code, yet providing a realistic view of how the app under development will look and behave. In this embodiment, the computing power that generates the appearance of the app takes place in the application module 450 of the CMS.

In an embodiment, the user authorization aspect of the A&D app may rely on multifactor authentication (MFA), in which additional evidence (i.e., a factor) besides a username and password is required to log in the server, such as a code sent by text or email to an address previously on file for the user, or a code from an authenticator app that has been previously set up for the user. MFA provides good security that prevents a bad actor with a stolen username and password from accessing an account, since a person with stolen credentials is unlikely to have access to the additional factor. This feature may be particularly important in application development procedures, since bad actors have been known to insert malware code into legitimate applications. Thus, MFA may help to prevent such attacks.

In an embodiment, the CMS may be hosted on a “cloud” service, and the CMS may operate as a cloud-based software as a service (“SaaS”) system. In an embodiment, an SaaS system includes a software licensing and delivery model in which software is licensed on a subscription basis and is centrally hosted on a server that users access through data networks. By the term “cloud service,” it is meant that the CMS operates on a remote computer server not owned by the user and with on-demand availability of computer system resources, especially data storage (cloud storage) and computing power, without direct active management by the user. The SaaS model likewise may have the advantage of putting the burden of updating features of the CMS on the CMS developer, without the need for updates or any computer management by the end users.

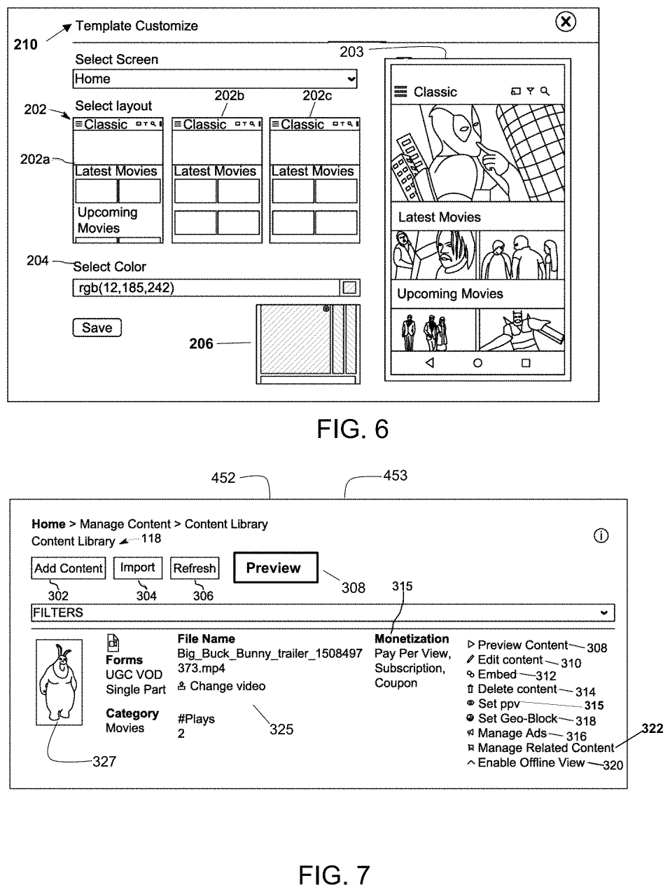

FIG. 6 is a screenshot of an embodiment of a template customization interface 210 in accordance with an exemplary embodiment of the present invention. The template customization interface 210 may include various layouts 202 such as 202a, 202b, 202c. The template customization interface may further include a preview 203 of a selected layout (202a is shown) with dummy/default content. The examples of application templates include templates for apps designed for Android®, iOS®, or lightweight Linux® operating systems. By the term “lightweight Linux® operating systems” is meant operating systems for devices such as Chromebook™ computers, Roku® devices, Amazon® Fire® devices, and similar devices. Many of these may be used in home theater-type applications, that manage video and audio content for consumers. Templates also include templates designed for operating on a computing device selected from a smartphone, a computer tablet, and a lightweight Linux computer. Templates may be directed generally to video content, audio content, news or blogs, communication apps, e-commerce apps, etc.

In the exemplary embodiment depicted in FIG. 6, the layouts 202 may present with various options such as different types of grids, different number of columns, and different number of rows. It would be readily apparent to those skilled in the art that various types of layouts 202 may be envisioned. In the exemplary embodiment of FIG. 6, the content is a combination of audio and video files. However, it would be readily apparent to those skilled in the art that the content may be audio, video, photos or combination of each of them, or any other type of app.

In another embodiment of the present invention, the template customization interface 210 further includes a user interface (UI) color scheme module 204 to allow the user to select color scheme using a color palette selector 206. The UI color scheme is adapted by the selected mobile application template such as the application template 202a.

In another embodiment of the present invention, the user input user interface 432 may allow users (i.e., developers) to select a different template, shown as 422 in FIG. 4.

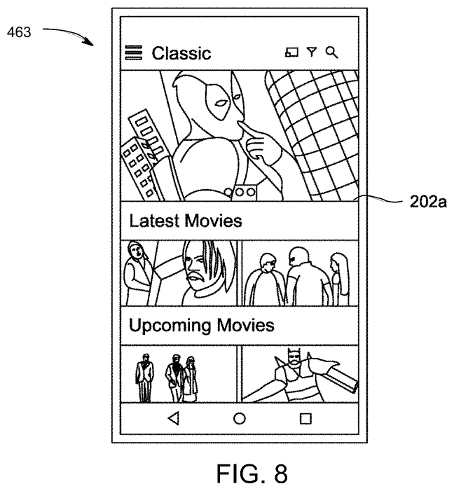

FIG. 7 is a screenshot of a user interface 453 for the content management module 452 (also called the content management system) in accordance with an exemplary embodiment of the present invention. The controls in FIG. 7 would operate within the Onyx A&D app 430 as part of the user input UI 432. The content management module 452 allows adding content through an add content tab 302, importing content through an import button 304 either from local database or a cloud, and refreshing the content through a refresh button 306. In an embodiment, the refresh button 306 may activate the inventive preview of the app. In an embodiment, a preview button 308 may be provided to present a preview of the app. An exemplary preview is shown in FIG. 8.

In an embodiment, with interface 453 the user can upload or add content such as audio, video, photos or a combination of audio, video, and photos. For example, this can include content in various formats such as .PNG, .JPEG, .MP4, .MP3, .PDF, SVG, .AAC, .BMP, HLS, .MPEG-DASH etc. It would be apparent to those skilled in the art that various content file formats may be employed.

FIG. 7 further shows file details (325) such as a file path and file name, permitted plays, format, and a thumbnail (327) of a content file.

The content management module interface 453 further allows the user to preview the added or uploaded content in the selected application template using a preview content button 308. In an embodiment, various other content management features are illustrated in FIG. 7, for example buttons to edit content 310, embed 312 a hyperlink/weblink, and delete content (314), mark a content as pay-per-view (PPV) (315), restrict geographic locations (marked “Geo-Block” 318), manage advertising (316), manage related content (for example, similar videos, 322), enable offline viewing (320).

In an embodiment, the content management module interface 453 further includes advertisement (“ad”) management module 316 to allow registered users to create advertisements to be viewed along the content through the application template. The type of advertisements includes, for example, server-side advertisements, client-side advertisements, ad tagging, pay per click, ad exchange, social media campaigns etc.

Further in another embodiment of the present invention, the content management module 452 further includes a monetization module 315 to allow registered users to access content. The registered users may access content through various payment modes such as pay per view (PPV), vouchers, subscription, coupons, credit etc. It would readily apparent to those skilled in the art that various types of payment modes for accessing content may be envisioned without deviating from the scope of the present invention.

In another embodiment of the present invention, the content management module 452 further includes a set geo block 318 to restrict the access to the mobile application and advertisements to specified countries or geo-locations.

Further in another embodiment of the present invention, the content management module 452 allows the registered user to download previously uploaded content in the database while in offline mode 320.

In another embodiment of the present invention, the database 454 stores the plurality of content selected in the content management module 452. The content management module 452 may further allow a registered user to manipulate the input content in the database. Examples of the manipulation include, for example, offline viewing, casting, digital rights management (DRM), translation, device restrictions etc.

The content management module 452 may further enable DRM protection for content in order to improve security and reduce piracy threats from downloads. In an exemplary embodiment of the present invention, the content management module 452 may secure the input content according to industry standard DRM protocols.

The content management module 452 may further provide options to translate the content in various languages to deliver content with multi-language audiences. Furthermore, the content management module 452 may set device and stream restrictions to the content, so the input content may be consumed by a limited number of devices and users.

FIG. 8 is a screenshot of an appearance preview 463 previewing of the input content as it would appear in preview interface 462 of the A&D app 430. This shows a preview as it would appear in a small screen on a smart phone. The illustrated app is the selected application template 202a, as shown in FIG. 6.

In an embodiment, a tokenized JSON based authentication may be implemented to handshake between the content management module and the application module to ensure security over tradition API authentication. Upon entering the username and password in the application downloaded from the application module, the application is rendered based on the JSON data received in the content management module, making all data dynamically driven from the backend. It would be apparent to those skilled in the art that various other processes can similarly be used to link the application module to handshake with the content management module such as XML, GSON, BSON, Jackson®, or any other similar stateless serialized token based authentication.

In an embodiment, users are able to load the application module 450 and develop apps for a digital distribution platform, including an Android® app, iOS® app, Android TV™ App, Fire TV® App, Apple TV® App, Samsung®, LG®, Xbox®, PlayStation®, Roku® and other similar IOT based devices etc. As used herein, a “digital distribution platform” means an app store, but a digital distribution platform can be any app installing or updating system, for example that updates a IoT device or a Roku device.

In an exemplary embodiment of the present invention as shown in FIG. 6, the downloaded application module is a mobile application displaying the content uploaded in the content management module, thus creating a customized application preview instantly in the application module.

The customized application displays the content input into the content management module in the selected application template. The customized application is updated instantly simultaneously to update and refresh of the content management module.

FIG. 9 is a screenshot showing a menu module 500 as part of an application element. This may be part of the feature marked 411 (FIG. 4) “Build elements in CMS.” The user interface 432 (FIG. 2) may include a menu module 500 to allow users to create a customized menu to be displayed in the selected application template.

The menu module 500 may allow the users to set a main menu in various categories such as content categories 502, static pages 504, apps 506 and external links 508. Further, the menu module allows the user to create menu structure 510 to be displayed on the selected application template. Furthermore, the menu structure selector 510 may allow the user to select an option of showing the menu either in a horizontal or a vertical position.

In the exemplary embodiment of FIG. 9, the menu structure 510 includes “my projects,” “projects funded by me,” “communities,” “help,” “terms and privacy policy,” and so forth. It would be readily apparent to those skilled in the art that various categories may be envisioned under main menu and menu structure 510.

FIG. 10 illustrates a screenshot of a template creation module 600 in accordance with another embodiment of this invention, showing an application template specifically designed for Android devices. In an embodiment, module 600 may be another feature of item 411 in FIG. 4. The user interface 432 (FIG. 2) may include a menu module 600 allowing users to create templates. As shown in FIG. 10, the user can select various themes such as “Modern” or “Classic” and various skins which include further decorative features.

This illustration further includes an template creation module 600 which is linked to the application template module 116 and the content management module (118, FIGS. 3 and 5) for creating content for ready-to-publish applications (also step 418 of FIG. 1).

In an embodiment, a ready-to-publish application (FIG. 4, step 418) may include the selected application template with the input content. An application creation module may send the ready-to-publish application over a communication network (not shown), wherein the ready-to-publish application comprises the selected application template with the input content and elements, for example elements created at step 411 (FIG. 4). The application creation module may be linked to the application template module and the content management module. The application creation module prepares an app prototype according to this invention for conversion to an actual, customized application that is compiled and ready for publication on an app store.

The present invention offers various advantages such as saving time to create a mobile application or an application for another lightweight operating system. This invention may further provide a mobile application with zero coding efforts. Furthermore, the present invention allows the user to instantly preview the desired content in the desired template without creating frameworks, without coding, and without the need for deployment.

Many brand names and trademarks are referred to herein. Over time, many of the marks and services will change, but persons of skill in the art would understand that successor marks and brands may fall within the scope of this invention. The inventors have developed an operational form of this invention called Muvi Onyx™.

Drawings Legend

| Number | Description |
|---|---|
| 202 | Template layouts |
| 202abc | Various specific templates of layouts |
| 203 | Template preview |
| 204 | Color selection interface |
| 206 | Color selection palette |
| 210 | template customization interface |
| 302 | Add content button |
| 304 | Import content button |
| 306 | Refresh content button |
| 308 | Preview content button |
| 310 | Edit content button |
| 312 | Embed content button |
| 314 | Delete content button |
| 315 | Set PPV button |
| 316 | Manage ads button |
| 318 | Set geo-block button |
| 320 | Enable offline viewing button |
| 325 | Content file details display |
| 327 | Content thumbnail |
| 400 | CMS Server |
| 410 | Run CMS |
| 411 | Build elements in CMS step |
| 412 | Template selection step |
| 413 | Select elements in CMS step |
| 418 | Ready to publish and compile step |
| 420 | Iterative changes step |
| 422 | Select new template step |
| 423 | Preview module |
| 430 | Authentication and display (A&D) app, |
| | called the “Onyx” app |
| 431 | Download A&D app |
| 432 | Login interface in A&D app |
| 434 | Login process |
| 436 | Authentication of credentials |
| 438 | Get customer details |
| 441 | Muvi CMS server components |
| 442 | Customer module |
| 444 | User database |
| 446 | Customer data |
| 450 | Application module |
| 452 | Content module |
| 453 | Content module interface |
| 454 | Content database |
| 456 | UI of A&D app that displays the |
| | app without compiling it |
| 460 | User input component of A&D app |
| 462 | Preview user interface |
| 463 | Appearance preview in preview user interface |
| 500 | Menu module |
| 502 | Illustrative menu items |
| 504 | Illustrative menu items |
| 506 | Illustrative menu items |
| 508 | Illustrative menu items |
| 510 | Menu structure selector |
| 600 | Template creation module illustration |

1.-11. (canceled)

12. A system for providing a rapid preview of the appearance of a compiled native computer application during an application development process where the computer application operates on a mobile computing device and wherein the computer application is not compiled during the preview, comprising:
an authorization and display app having a user interface running on a mobile computing device using a mobile operating system where applications are normally only installed from an application store;
wherein the authorization and display app is in network communication with a Content Management System (CMS) server having an application module, a user database, and a content database;
wherein the user database stores user information and one or more user templates;
wherein the content database stores content data files selected by the user;
wherein an authentication system accepts user credentials on the authorization and display app and connects the user to the CMS server from the authorization and display app using the user credentials;
wherein the user can select user templates and content files when logged in to the CMS server wherein the user templates and content are intended for use as a compiled native computer application operating on a mobile computing device;
wherein the application module merges user templates and content files and renders a preview of the compiled native application on the user interface of the authorization and display app without compiling computer code.

13. The system according to claim 12, wherein the mobile operating system is selected from Android or iOS.

14. The system according to claim 12 wherein the content management server is cloud-based.

15. The system according to claim 12 wherein the content management server is provided as software as a service (SaaS).
